(19) United States
(12) Patent Application Publication
(10) Pub. No.: US 2016/0298545 A1
(43) Pub. Date: Oct. 13, 2016

(54) TURBINE AIRFOIL

(71) Applicant: General Electric Company, Schenectady, NY (US)

(72) Inventors: Xiuzhang James Zhang, Simpsonville, SC (US); Sandip Dutta, Greenville, SC (US); Gary Michael Itzel, Simpsonville, SC (US)

(21) Appl. No.: 14/684,908

(22) Filed: Apr. 13, 2015

(51) Int. Cl. F02C 7/18; F01D 5/02; F02C 3/06; F01D 5/18

(52) U.S. Cl. CPC F02C 7/185; F01D 5/187; F01D 5/02; F02C 3/06; F05D 2220/3212; F05D 2230/11; F05D 2240/24; F05D 2240/307; F05D 2240/306; F05D 2240/35; F05D 2260/20

(57) ABSTRACT

A turbine airfoil includes a leading edge, a trailing edge, a root and a tip. Also included is a pressure side wall extending between the leading edge and the trailing edge and between the root and the tip. Further included is a suction side wall extending between the leading edge and the trailing edge and between the root and the tip. Yet further included is a non-circular cooling channel defined by the turbine airfoil and extending radially from the root to the tip, the non-circular cooling channel routing a cooling air to an outlet hole formed in the tip. Also included is an exhaust hole defined by the turbine airfoil and extending from the non-circular cooling channel to the suction side wall, the exhaust hole radially located between the root and the tip.

### BACKGROUND OF THE INVENTION

The subject matter disclosed herein relates to gas turbine engines and, more particularly, to a turbine airfoil for such engines.

In turbine engines, such as gas turbine engines or steam turbine engines, fluids at relatively high temperatures contact blades that are configured to extract mechanical energy from the fluids to thereby facilitate a production of power and/or electricity. While this process may be highly efficient for a given period, over an extended time, the high temperature fluids tend to cause damage that can degrade performance and increase operating costs.

Accordingly, it is often necessary and advisable to cool the blades in order to at least prevent or delay premature failures. This can be accomplished by delivering relatively cool compressed air to the blades to be cooled. In many traditional gas turbines, in particular, this compressed air enters the bottom of each of the blades to be cooled and flows through one or more round machined passages in the radial direction to cool the blade through a combination of convection and conduction.

In these traditional gas turbines, as the temperature of the fluids increases, it becomes necessary to increase the amount of cooling flow through the blades. This increased flow can be accomplished by an increase in a size of the cooling holes. However, as the cooling holes increase in size, the wall thickness of each hole to the external surface of the blade decreases and eventually challenging manufacturability and structural integrity of the blade.

### BRIEF DESCRIPTION OF THE INVENTION

According to one aspect of the invention, a turbine airfoil includes a leading edge, a trailing edge, a root and a tip. Also included is a pressure side wall extending between the leading edge and the trailing edge and between the root and the tip. Further included is a suction side wall extending between the leading edge and the trailing edge and between the root and the tip. Yet further included is a non-circular cooling channel defined by the turbine airfoil and extending radially from the root to the tip, the non-circular cooling channel routing a cooling air to an outlet hole formed in the tip. Also included is an exhaust hole defined by the turbine airfoil and extending from the non-circular cooling channel to the suction side wall, the exhaust hole radially located between the root and the tip.

According to another aspect of the invention, a gas turbine engine includes a compressor section, a combustor section, and a turbine section. The turbine section includes a turbine airfoil having a plurality of cooling channels defined by the turbine airfoil, at least one of the plurality of cooling channels being a non-circular cooling channel and at least one of the plurality of cooling channels being a circular cooling channel. The turbine section also includes an exhaust hole defined by the turbine airfoil and extending from the non-circular cooling channel to a suction side wall of the turbine airfoil for fluidly coupling the non-circular cooling channel and a hot gas path of the turbine section.

According to yet another aspect of the invention, a turbine airfoil includes a leading edge, a trailing edge, a root and a tip. Also included is a pressure side wall extending between the leading edge and the trailing edge and between the root and the tip. Further included is a suction side wall extending between the leading edge and the trailing edge and between the root and the tip. Yet further included is a plurality of non-circular cooling channels defined by the turbine airfoil and extending radially between the root and the tip. Also included is a plurality of circular cooling channels defined by the turbine airfoil and extending radially between the root and the tip, wherein all of the plurality of non-circular cooling channels are located between the leading edge and the plurality of circular cooling channels. Further included is a plurality of exhaust holes, each of the plurality of exhaust holes extending between one of the plurality of non-circular cooling channels and the suction side wall to fluidly couple the plurality of non-circular cooling channels and an exterior region of the turbine airfoil, each of the plurality of exhaust holes radially located between the root and the tip.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a perspective view of a turbine airfoil; and

FIG. 3 is a cross-sectional view of the turbine airfoil taken along line A-A of FIG. 2.

The detailed description explains embodiments of the invention, together with advantages and features, by way of example with reference to the drawings.

### DETAILED DESCRIPTION OF THE INVENTION

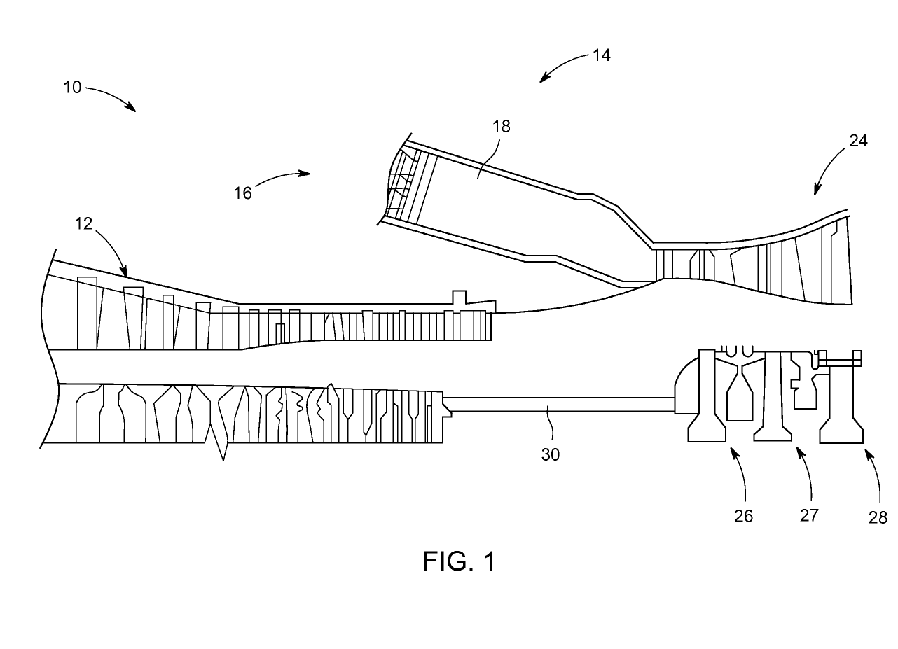

Referring to FIG. 1, a turbine system, such as a gas turbine engine 10, constructed in accordance with an exemplary embodiment of the present invention is schematically illustrated. The gas turbine engine 10 includes a compressor section 12 and a plurality of combustor assemblies arranged in a can annular array, one of which is indicated at 14. The combustor assembly is configured to receive fuel from a fuel supply (not illustrated) and a compressed air from the compressor section 12. The fuel and compressed air are passed into a combustor chamber 18 and ignited to form a high temperature, high pressure combustion product or air stream that is used to drive a turbine 24. The turbine 24 includes a plurality of stages 26-28 that are operationally connected to the compressor 12 through a compressor/turbine shaft 30 (also referred to as a rotor).

In operation, air flows into the compressor 12 and is compressed into a high pressure gas. The high pressure gas is supplied to the combustor assembly 14 and mixed with fuel, for example natural gas, fuel oil, process gas and/or synthetic gas (syngas), in the combustor chamber 18. The fuel/air or combustible mixture ignites to form a high pressure, high temperature combustion gas stream, which is channeled to the turbine 24 and converted from thermal energy to mechanical, rotational energy.

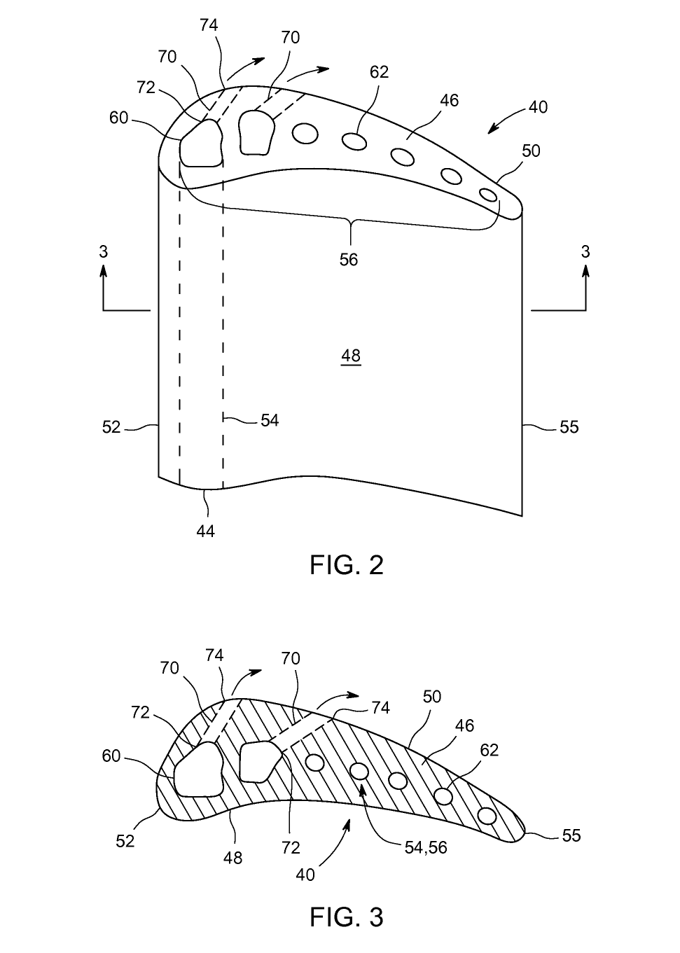

Referring now to FIGS. 2 and 3, with continued reference to FIG. 1, a perspective view of a portion of a turbine airfoil 40 (also referred to as a “turbine bucket,” “turbine blade airfoil” or the like) is illustrated. It is to be appreciated that the turbine airfoil 40 may be located in any stage of the turbine 24. In one embodiment, the turbine airfoil 40 is located within the illustrated first stage (i.e., stage 26) of the turbine 24. Although only three stages are illustrated, it is to be appreciated that more or less stages may be present. In any event, the turbine airfoil 40 extends radially from a root portion 44 to a tip portion 46. The turbine airfoil 40 includes a pressure side wall 48 and a suction side wall 50, where the geometry of the turbine airfoil 40 is configured to provide rotational force for the turbine 24 as fluid flows over the turbine airfoil 40. As depicted, the suction side wall 50 is convex-shaped and the pressure side wall 48 is concave-shaped. Also included are a leading edge 52 and a trailing edge 55, which are joined by the pressure side wall 48 and the suction side wall 50. Although the following discussion primarily focuses on gas turbines, the concepts discussed are not limited to gas turbine engines and may be applied to any rotary machine employing turbine blades.

The pressure side wall 48 and the suction side wall 50 are spaced apart in the circumferential direction over the entire radial span of the turbine airfoil 40 to define at least one internal flow chamber or channel for channeling cooling air through the turbine airfoil 40 for the cooling thereof In the illustrated embodiment, a plurality of cooling channels 54 is illustrated, with each of the channels spaced along a length of the turbine airfoil 40. Cooling air is typically bled from the compressor section 12 in any conventional manner. The cooling air is discharged through at least one, but typically a plurality of outlet holes 56 located at the tip portion 46 of the turbine airfoil 40.

The plurality of cooling channels 54 may be machined by way of electro-chemical machining processes (ECM), for example. In one embodiment, the plurality of cooling channels 54 is formed from shaped tube electrolyzed machining (STEM). Regardless of the precise machining process, the cooling air is made to flow in a radial direction along a length of the cooling channels 54 by fluid pressure and/or by centrifugal force. As the cooling air flows, heat transfer occurs between the turbine airfoil 40 and the cooling air. In particular, the cooling air removes heat from the turbine airfoil 40 and, in addition, tends to cause conductive heat transfer within solid portions of the turbine airfoil. The conductive heat transfer may be facilitated by the turbine airfoil 40 being formed of metallic material, such as metal and/or a metal alloy that is able to withstand relatively high temperature conditions. The overall heat transfer decreases a temperature of the turbine airfoil 40 from what it would otherwise be as a result of contact between the turbine airfoil 40 with, for example, relatively high temperature fluids flowing through the gas turbine engine 10.

Although it is contemplated that all of the plurality of cooling channels 54 are formed of a similar cross-sectional geometry, in the illustrated embodiment at least one of the cooling channels 54 may be defined as having a substantially non-circular cross-sectional shape and is referred to herein as a non-circular cooling channel 60, while at least one of the plurality of cooling channels 54 has a cross-sectional geometry that is circular and is referred to herein as a circular cooling channel 62. The non-circular shape of the non-circular cooling channel allows for an increased perimeter and larger cross-sectional area of the cooling channel and leads to a greater degree of heat transfer without a thickness of the wall having to be sacrificed beyond a wall thickness that is required to maintain manufacturability and structural integrity. As illustrated, a plurality of cooling holes may have the aforementioned non-circular geometry and similarly a plurality of cooling holes may have the circular geometry.

Where the cooling hole(s) is non-circular, the cooling channel may have various alternative shapes including, but not limited to, elliptical or otherwise elongated shapes. The cooling channel may be rounded or angled, regular or irregular. The cooling channel may be symmetric about a predefined axis or non-symmetric about any predefined axis. The cooling channel may be defined with elongate sidewalls that have profiles mimicking local profiles of the pressure and suction side walls, such that the wall channel wall is elongated with a thickness that is equal to or greater than a wall thickness required for the maintenance of manufacturability and structural integrity. Similarly, the cooling channel may be longer in an axial direction of the turbine airfoil 40 than a circumferential direction thereof and/or may have an aspect ratio that is less than or greater than 1, non-inclusively.

The substantial non-circularity of the non-circular cooling channel 60 may be localized, may extend along a partial radial length of the non-circular cooling channel 60 or may extend along an entire radial length of the non-circular cooling channel 60. In this way, the increased heat transfer facilitated by the substantial non-circularity of the non-circular cooling channel 60 may be provided to only a portion of the length of the turbine airfoil or to a portion along the entire length of the turbine airfoil 40.

The relative positioning of the non-circular cooling channel(s) 60 and the circular cooling channel(s) 62 is illustrated. In particular, in one embodiment, all of the non-circular cooling channels 60 are located between the circular cooling channels 62 and the leading edge 52, such that the non-circular cooling channels 60 are closer in proximity to the leading edge 52 relative to the proximity of the circular cooling channels 62 to the leading edge 52.

To reduce the pressure within the non-circular cooling channels 60, thereby lowering the supply pressure needed to effectively route the cooling air through the channels, at least one exhaust hole 70 is included and defined by the turbine airfoil 40. In particular, each non-circular cooling channel 60 includes at least one exhaust hole, but possibly a plurality of exhaust holes, to form an airway through the turbine airfoil 40 between the non-circular cooling channel 60 and an exterior region of the turbine airfoil 40, such as a hot gas path, on the suction side wall 50 side of the turbine airfoil 40. The exhaust hole 70 is configured to bleed the cooling air out of the non-circular cooling channel 60 into a hot gas path to reduce the pressure within the cooling channel. The exhaust hole 70 includes an exhaust hole inlet 72 at the location of intersection with the non-circular cooling channel 60 and an exhaust hole outlet 74 at the suction side wall 50. Although it is contemplated that the exhaust hole 72 is located radially at any location along the turbine airfoil 40, typically all or a portion of the exhaust hole 70 is located closer to the tip portion 46 than to the root portion 44.

Positioning of the non-circular cooling channel 60 near the leading edge 52 of the turbine airfoil 40 and inclusion of the associated exhaust hole(s) is beneficial based on the higher pressure present near the leading edge 52. This higher pressure near the leading edge 52 poses a challenge to maintain the required cooling flow through channels close to leading edge 52. For a given supply pressure at the root of the bucket, reducing cavity pressure (i.e., sink pressure) in this region is desirable which ensures overall cooling of the airfoil near leading edge.

The exhaust hole 70 may be formed of any suitable geometry. For example, ellipses, circles, squares or rectangles may be employed, but the preceding list is not exhaustive. As such, it is to be understood that the illustrated and above-noted geometries are not limiting of the shapes that may be employed. Regardless of the precise shape of the holes, it is contemplated that the cross-sectional shape of the holes may remain constant throughout the length of the holes or may vary as a function of length. Additionally, as shown, the exhaust hole 70 may extend through the turbine airfoil 40 at an angle to enhance the tendency of the cooling air to escape into the hot gas path through the holes. Angling of the exhaust hole 70 refers to aligning the exhaust hole in such a way that cooling flow coming out of the hole mixes smoothly with the hot gas flowing over the suction surface of the airfoil. Typically, this includes angling the exhaust hole 70 in an orientation that disposes the exhaust hole inlet 72 closer in proximity to the leading edge 52 when compared to the proximity of the exhaust hole outlet 74. In other words, the exhaust hole 70 angles toward the trailing edge 55, from inlet to outlet. However, alternative angling is contemplated. For example, the exhaust hole 70 may angle toward the leading edge 52, from inlet to outlet. Additionally, the exhaust hole 70 may angle radially. For example, the exhaust hole 70 may angle from root portion 44 to tip portion 46, or vice versa, from inlet to outlet.

Advantageously, the combination of non-circular cooling channels and exhaust holes associated with the cooling channels avoids the need to increase the supply pressure to ensure sufficient routing of the cooling air through the turbine airfoil. Additionally, the embodiments described herein avoid the need to redesign the overall turbine airfoil geometry, thus maintaining the aerodynamic performance of the turbine airfoil within the application, such as a gas turbine engine.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbine airfoil comprising:
a leading edge;
a trailing edge;
a root;
a tip;
a pressure side wall extending between the leading edge and the trailing edge and between the root and the tip;
a suction side wall extending between the leading edge and the trailing edge and between the root and the tip;
a non-circular cooling channel defined by the turbine airfoil and extending radially from the root to the tip, the non-circular cooling channel routing a cooling air to an outlet hole formed in the tip; and
an exhaust hole defined by the turbine airfoil and extending from the non-circular cooling channel to the suction side wall, the exhaust hole radially located between the root and the tip.

2. The turbine airfoil of claim 1, further comprising a plurality of exhaust holes defined by the turbine airfoil, each of the plurality of exhaust holes extending between the non-circular cooling channel and the suction side wall.

3. The turbine airfoil of claim 1, wherein the non-circular cooling channel comprises a non-circular geometry along an entire length thereof.

4. The turbine airfoil of claim 1, wherein the exhaust hole comprises an exhaust hole inlet and an exhaust hole outlet, the exhaust hole angled to dispose the exhaust hole outlet closer in proximity to the tip relative to the exhaust hole inlet proximity to the tip.

5. The turbine airfoil of claim 1, wherein the exhaust hole comprises an exhaust hole inlet and an exhaust hole outlet, the exhaust hole angled to dispose the exhaust hole inlet closer in proximity to the tip relative to the exhaust hole outlet proximity to the tip.

6. The turbine airfoil of claim 1, wherein the exhaust hole is located closer in proximity to the tip than to the root.

7. The turbine airfoil of claim 1, further comprising a circular cooling channel defined by the turbine airfoil and extending radially from the root to the tip, the circular cooling channel routing the cooling air radially through the turbine airfoil.

8. The turbine airfoil of claim 7, wherein the non-circular cooling channel is located closer in proximity to the leading edge relative to the circular cooling channel proximity to the leading edge.

9. The turbine airfoil of claim 1, further comprising a plurality of non-circular cooling channels, each of the plurality of non-circular cooling channels comprising at least one exhaust hole fluidly coupled thereto.

10. The turbine airfoil of claim 1, wherein the turbine airfoil is disposed in a gas turbine engine.

11. The turbine airfoil of claim 10, wherein the turbine airfoil is disposed in a first stage of a turbine section of the gas turbine engine.

12. The turbine airfoil of claim 1, wherein the non-circular cooling channel is formed from shaped tube electrolyzed machining.

13. A gas turbine engine comprising:
a compressor section;
a combustor section; and
a turbine section comprising:
a turbine airfoil having a plurality of cooling channels defined by the turbine airfoil, at least one of the plurality of cooling channels being a non-circular cooling channel and at least one of the plurality of cooling channels being a circular cooling channel; and
an exhaust hole defined by the turbine airfoil and extending from the non-circular cooling channel to a suction side wall of the turbine airfoil for fluidly coupling the non-circular cooling channel and a hot gas path of the turbine section.

14. The gas turbine engine of claim 13, further comprising a plurality of exhaust holes defined by the turbine airfoil, each of the plurality of exhaust holes extending between the non-circular cooling channel and the suction side wall.

15. The gas turbine engine of claim 13, wherein the exhaust hole comprises an exhaust hole inlet and an exhaust hole outlet, the exhaust hole angled to dispose the exhaust hole outlet closer in proximity to a tip of the turbine airfoil relative to the exhaust hole inlet proximity to the tip.

16. The gas turbine engine of claim 13, wherein the exhaust hole comprises an exhaust hole inlet and an exhaust hole outlet, the exhaust hole angled to dispose the exhaust hole inlet closer in proximity to a tip of the turbine airfoil relative to the exhaust hole outlet proximity to the tip.

17. The gas turbine engine of claim 13, wherein the exhaust hole is located closer in proximity to a tip of the airfoil than to a root of the turbine airfoil.

18. The gas turbine engine of claim 13, wherein the non-circular cooling channel is located closer in proximity to a leading edge of the turbine airfoil relative to the circular cooling channel proximity to the leading edge.

19. A turbine airfoil comprising:
a leading edge;
a trailing edge;
a root;
a tip;
a pressure side wall extending between the leading edge and the trailing edge and between the root and the tip;
a suction side wall extending between the leading edge and the trailing edge and between the root and the tip;
a plurality of non-circular cooling channels defined by the turbine airfoil and extending radially between the root and the tip;
a plurality of circular cooling channels defined by the turbine airfoil and extending radially between the root and the tip, wherein all of the plurality of non-circular cooling channels are located between the leading edge and the plurality of circular cooling channels; and
a plurality of exhaust holes, each of the plurality of exhaust holes extending between one of the plurality of non-circular cooling channels and the suction side wall to fluidly couple the plurality of non-circular cooling channels and an exterior region of the turbine airfoil, each of the plurality of exhaust holes radially located between the root and the tip.

20. The turbine airfoil of claim 19, wherein the turbine airfoil is disposed in a first stage of a turbine section of a gas turbine engine.
